(19) United States
(12) Patent Application Publication
(10) Pub. No.: US 2021/0403679 A1
(43) Pub. Date: Dec. 30, 2021

(54) Resin Composition

(71) Applicant: MCC Advanced Moldings Co., Ltd., Tokyo (JP)

(72) Inventors: Yuuki Komatsu, Mie (JP); Kouichi Sagisaka, Mie (JP)

(73) Assignee: MCC Advanced Moldings Co., Ltd., Tokyo (JP)

(21) Appl. No.: 17/474,187

(22) Filed: Sep. 14, 2021

Related U.S. Application Data
(63) Continuation of application No. PCT/JP2020/012210, filed on Mar. 19, 2020.

(30) Foreign Application Priority Data
Mar. 26, 2019 (JP) 2019-057829

(51) Int. Cl. C08K 7/06; C08K 3/04

(52) U.S. Cl. CPC C08K 7/06; C08K 3/04

(57) ABSTRACT

Provided is a resin composition having electrical conductivity and low water absorbency. The resin composition comprises a carbon fiber and a thermoplastic resin, the carbon fiber having a relative intensity ratio (I_{D}/I_{G}) of the peak intensity I_{D} in a wavenumber range of 1,320 cm⁻¹ to 1,370 cm⁻¹ to the peak intensity I_{G} in a wavenumber range of 1,560 cm⁻¹ to 1,600 cm⁻¹ of 0.6 or less in the Raman spectrum measured by microscopic Raman spectroscopy, the resin composition having a surface resistance value in a range of 1×10² Ω to 1×10¹² Ω.

### TECHNICAL FIELD

The present invention relates to a resin composition, especially to a resin composition suitably used for forming containers and the like used in the electrical and electronic fields where low water absorbency and electrical conductivity are required.

### BACKGROUND ART

For example, in a semiconductor manufacturing process, containers for semiconductor storage and transportation formed by using a resin composition are used for transporting and storing wafers and the like. The performance required for containers that store and transport electronic devices such as semiconductor wafers includes mechanical strength of the containers, and antistatic properties and low water absorbency for protecting electronic components such as semiconductors stored in the containers. The container having antistatic properties suppresses the absorption of dirt and dust, and reduces circuit breakage or the like of electronic components stored in the container. The container having low water absorbency suppresses the water absorption and release of moisture from the container itself, and reduces breakage of electronic components stored in the container due to the moisture. With increase of the density of semiconductor integrated circuits, the demand for antistatic properties and low water absorbency for containers tends to increase more and more.

Many containers for transporting and storing electronic components are formed by using a resin composition. In order to form a container having antistatic properties, the electrical conductivity of the matrix resin itself in the resin composition forming the container has been improved, or the antistatic properties of the container has been improved by adding a highly conductive carbon filler or the like to the resin composition.

For example, Patent Document 1 discloses a resin composition containing a cyclic olefin homopolymer, a fibrous conductive filler, and an elastomer. The resin composition described in Patent Document 1 contains a cyclic olefin homopolymer to suppresses outgas generated from the resin composition, and a fibrous conductive filler to impart mechanical strength and electrical conductivity, thereby improving the antistatic properties. However, the resin composition described in Patent Document 1 does not improve the low water absorbency.

### CITATION LIST

### Patent Document

Patent Document 1: Japanese Patent Laid-Open No. 2013-231171

### SUMMARY OF THE INVENTION

### Problem to be Solved by the Invention

Considering the above circumstances and the problem to be solved, the present invention is to provide a resin composition having electrical conductivity and low water absorbency that can be suitably used for containers and the like in the electrical and electric fields requiring electrical conductivity.

### Means for Solving Problem

As a result of intensive studies in view of the above circumstances, the present inventors have found that the above-mentioned problem can be easily solved by a resin composition containing a carbon fiber having a relative intensity ratio in a specific range in the Raman spectrum and a thermoplastic resin, which led to the completion of the present invention.

That is, the gist of the present invention is to provide a resin composition containing a carbon fiber having a relative intensity ratio (I_{D}/I_{G}) of the peak intensity I_{D} in a wavenumber range of 1,320 cm⁻¹ to 1,370 cm⁻¹ to the peak intensity I_{G} in a wavenumber range of 1,560 cm⁻¹ to 1,600 cm⁻¹ in the Raman spectrum measured by microscopic Raman spectroscopy of 0.6 or less and a thermoplastic resin, wherein the surface resistance value is in a range of 1×10² Ω to 1×10¹² Ω.

### Effect of the Invention

The present invention is capable of providing a resin composition having excellent electrical conductivity and low water absorbency that can be suitably used for forming containers and the like in the electrical and electric fields requiring electrical conductivity.

### MODE(S) FOR CARRYING OUT THE INVENTION

Hereinafter, an example of the embodiment of the present invention will be described in detail. However, the present invention is not limited to the example of the embodiment described below, and can be arbitrarily modified and implemented as long as the gist of the present invention is not deviated.

The resin composition according to the embodiment of the present invention contains a carbon fiber and a thermoplastic resin, wherein the carbon fiber has a relative intensity ratio (I_{D}/I_{G}) of the peak intensity I_{D} in a wavenumber range of 1,320 cm⁻¹ to 1,370 cm⁻¹ to the peak intensity I_{G} in a wavenumber range of 1,560 cm⁻¹ to 1,600 cm⁻¹ in the Raman spectrum measured by microscopic Raman spectroscopy of 0.6 or less, and wherein the surface resistance value is in a range of 1×10² Ω to 1×10¹² Ω.

Carbon Fiber

The resin composition according to the embodiment of the present invention contains a carbon fiber having a relative intensity ratio (I_{D}/I_{G}) of 0.6 or less and a thermoplastic resin. Since the carbon fiber is contained in the resin composition such that the surface resistance value is in a range of 1×10² Ω to 1×10¹² Ω, a molded product formed from the resin composition not only has electrical conductivity but also reduces water absorbency.

In the Raman spectrum of the carbon fiber measured by microscopic Raman spectroscopy, the peak appearing in a wavenumber range of 1,560 cm⁻¹ to 1,600 cm⁻¹ is a peak commonly appearing in carbon materials and is a peak derived from a graphite structure of the carbon fiber. In the Raman spectrum of the carbon fiber, the peak appearing in a wavenumber range of 1,320 cm⁻¹ to 1,370 cm⁻¹ is a peak derived from disorder or defect of the graphite structure. In the Raman spectrum of the carbon fiber, the relative intensity ratio I_{D}/I_{G} of the peak intensity I_{D} in a wavenumber range of 1,320 cm⁻¹ to 1,370 cm⁻¹ to the peak intensity I_{G} in a wavenumber range of 1,560 cm⁻¹ to 1,600 cm⁻¹ may be referred to as the Raman value (R value), and has a correlation with the graphitization degree of the carbon fiber. The larger the graphitization degree, the smaller the Raman value (R value). The larger the graphitization degree, the higher the crystallinity and the closer the arrangement of crystallites to that of natural graphite. When the relative intensity ratio I_{D}/I_{G} of the carbon fiber is more than 0.6, the crystallinity is low, the graphitization degree is too small, the water absorptivity is high, and thus the water absorbency cannot be reduced. The relative intensity ratio I_{D}/I_{G} of the carbon fiber is 0.6 or less, preferably 0.5 or less, and more preferably 0.4 or less; and is preferably 0.12 or more, more preferably 0.13 or more, even more preferably 0.14 or more, still more preferably 0.15 or more, and particularly preferably 0.16 or more. When the value of the relative intensity ratio I_{D}/I_{G} of the carbon fiber becomes too small, the graphitization degree increases, the carbon fiber becomes hard, and the carbon fiber may break when the thermoplastic resin and the carbon fiber are kneaded.

The carbon fiber can be measured by microscopic Raman spectroscopy even if it is for the Raman spectrum of the carbon fiber itself, that of the carbon fiber in the resin composition, or that of the carbon fiber in a molded product such as a sheet formed from the resin composition. From these Raman spectra, the relative intensity ratio of the peak intensity in a specific wavenumber range to the peak intensity in another specific wavenumber range can be measured. The Raman spectrum of the carbon fiber can be measured according to the method in Examples described later, and can be measured by microscopic Raman spectroscopy measurement method using a micro laser Raman spectroscopic analyzer (for example, product name: DXR2 microscopic laser Raman microscope). For example, when measuring the Raman spectrum of the carbon fiber in a pellet or a molded product formed from the resin composition, the Raman spectrum of the resin contained in the composition is measured in advance, and then the Raman spectrum of the pellet or the molded product is measured. From the difference spectrum of these Raman spectra, the Raman spectrum of the carbon fiber can be measured, and the relative intensity ratio I_{D}/I_{G} can be determined from this Raman spectrum.

Examples of the carbon fiber include pitch-based carbon fibers, polyacrylonitrile (PAN)-based carbon fibers, rayon-based carbon fibers, and phenol-based carbon fibers. It is preferable to use pitch-based carbon fibers since the graphitization treatment is relatively easy and a desired R value can be easily obtained.

The carbon fiber may be subjected to graphitization treatment. Various methods can be used for the graphitization treatment. Examples thereof include a method of heating at 1,500° C. to 3,500° C. in an inert atmosphere. In general, when the temperature of the graphitization treatment is high, the degree of graphitization is increased. The temperature of the graphitization treatment is preferably in a range of 2,000° C. to 3,500° C. since it is easier to obtain a desired R value.

The carbon fiber may be bundled with a sizing agent from the viewpoint of improving handleability. The sizing agent is a bundling agent that disperses and attaches the carbon fiber to the resin, or is added to the carbon fiber to bundle the fiber. Examples of the sizing agent include an epoxy resin, a urethane resin, and a mixture of these. In order to reduce outgas generated from organic materials, the amount of the sizing agent is preferably 3% by mass or less relative to 100% by mass of the total amount of the carbon fiber. When the carbon fiber is bundled by the sizing agent, the fiber length of the bundled carbon fiber is preferably 3 to 6 mm.

The average fiber diameter of the carbon fiber is preferably in a range of 3 to 15 μm, more preferably in a range of 5 to 13 μm, and even more preferably in a range of 7 to 12 μm. When the average fiber diameter of the carbon fiber falls within the range of 3 to 15 μm, the carbon fiber is less likely to break when kneaded with a thermoplastic resin to obtain a resin composition, and a molded product having a desired surface resistance value can be formed. The average fiber diameter of the carbon fiber can be determined, for example, by measuring the minor axis of ten carbon fibers with an optical microscope and averaging the measured values. The average fiber diameter of the carbon fiber may be a known value such as a catalog value, or may be a measured value.

The average fiber length of the carbon fiber is preferably in a range of 1 to 10 mm, more preferably in a range of 2 to 9 mm, even more preferably in a range of 3 to 8 mm, and particularly preferably in a range of 3 to 7 mm. When the average fiber length of the carbon fiber falls within the range of 1 to 10 mm, the carbon fiber is easily kneaded and less likely to break in kneading with a thermoplastic resin to obtain a resin composition, so that a resin composition capable of forming a molded product having a desired surface resistance value can be obtained. The average fiber length of the carbon fiber can be determined as the number-average fiber length, for example, by measuring the length of ten carbon fibers with an optical microscope and averaging the measured values. The average fiber length of the carbon fiber may be a known value such as a catalog value, or may be a measured value.

The aspect ratio of the carbon fiber in the resin composition is preferably 10 or more, and more preferably 20 or more; and is preferably 3,000 or less, and more preferably 2,000 or less. When the aspect ratio of the carbon fiber is less than 10, it is difficult for the carbon fiber to form a network in the resin composition, and it may not be possible to form a molded product having sufficient electrical conductivity. The aspect ratio (average fiber length/average fiber diameter) can be determined from the average fiber length and the average fiber diameter of the carbon fiber using an optical microscope.

The content of the carbon fiber in the resin composition is preferably in a range of 1% by mass to 50% by mass, more preferably in a range of 3% by mass to 45% by mass, even more preferably in a range of 5% by mass to 40% by mass, and particularly preferably in a range of 10% by mass to 35% by mass, relative to the total amount (100% by mass) of the resin composition. When the content of the carbon fiber in the resin composition falls within the range of 1% by mass to 50% by mass, the resin composition has sufficient electrical conductivity when used in the electrical and electric fields, and the molded product formed from the resin composition has a desired surface resistance value to facilitate molding such as injection molding.

Thermoplastic Resin

Examples of the thermoplastic resin include polyester-based resins such as a polyether-ether-ketone resin, a polyphenylene sulfide resin, a polyetherimide resin, a polyether sulfone resin, a polysulfone resin, a polyarylate resin, a modified polyphenylene ether resin, a polyacetal resin, a polycarbonate resin, a polybutylene terephthalate resin, and a polyethylene terephthalate resin; polyamide-based resins such as nylon 6 and nylon 66; styrene-based resins such as a polystyrene resin and an ABS resin; polyolefin-based resins such as a cyclic olefin polymer (COP), a cyclic olefin copolymer (COC), polypropylene, and polyethylene; fluororesins such as polyvinylidene fluoride, polytetrafluoroethylene-ethylene copolymer (ETFE), and tetrafluoroethylene-perfluoroalkyl vinyl ether copolymer (PFA); olefin-based elastomers such as ethylene propylene rubber (EPR); styrene-based elastomers such as a hydrogenated styrene-based thermoplastic elastomer (SEBS); polyester-based elastomers; and thermoplastic elastomers such as a polyurethane elastomer, a polyamide elastomer, a silicone elastomer, and an acrylic elastomer. Among these, it is preferably at least one type of the groups consisting of polyester-based resins such as a polyether-ether-ketone resin, a polyphenylene sulfide resin, a polyether sulfone resin, a polysulfone resin, a polyarylate resin, a modified polyphenylene ether resin, a polyacetal resin, a polycarbonate resin, a polybutylene terephthalate resin, and a polyethylene terephthalate resin; styrene-based resins such as a polystyrene resin and an ABS resin; polyolefin-based resins such as a cyclic olefin polymer (COP), a cyclic olefin copolymer (COC), polypropylene, and polyethylene; fluororesins such as polyvinylidene fluoride, polytetrafluoroethylene-ethylene copolymer (ETFE), and tetrafluoroethylene-perfluoroalkyl vinyl ether copolymer (PFA); olefin-based elastomers such as ethylene propylene rubber (EPR); styrene-based elastomers such as a hydrogenated styrene-based thermoplastic elastomer (SEBS); and polyester-based elastomers. Among these, it is more preferably at least one type of the groups consisting of polyolefin-based resins such as a cyclic olefin polymer (COP), a cyclic olefin copolymer (COC), polypropylene, and polyethylene; fluororesins such as polyvinylidene fluoride, a polytetrafluoroethylene-ethylene copolymer (ETFE), and a tetrafluoroethylene-perfluoroalkyl vinyl ether copolymer (PFA); and olefin-based elastomers such as ethylene propylene rubber (EPR). Among these, it is particularly preferably at least one type selected from a cyclic olefin polymer (COP) and a cyclic olefin copolymer (COC).

The thermoplastic resin is preferably at least one type selected from a cyclic olefin polymer (COP) and a cyclic olefin copolymer (COC) having low water absorbency and excellent moldability capable of forming a molded product with high dimensional accuracy. The cyclic olefin polymer (COP) is a cyclic olefin ring-opening (co)polymer having at least one olefinic double bond in the cyclic hydrocarbon structure, such as cyclopentene, norbornene, and tetracyclo[6,2,11,8,13,6]-4-dodecene, or a hydrogenated product thereof. The cyclic olefin copolymer (COC) is an addition copolymer of a cyclic olefin and an α-olefin or the like or a hydrogenated product thereof, or an addition polymer of a cyclic olefin and a cyclic diene or a hydrogenated product thereof. Examples of COP include cyclic olefin polymers such as those described in Japanese Patent Laid-Open No. H01-168724 and Japanese Patent Laid-Open No. H01-168725. Examples of COC include cyclic olefin copolymers such as those described in Japanese Patent Laid-Open No. S60-168708, Japanese Patent Laid-Open No.H06-136057, and Japanese Patent Laid-Open No. H07-258362. As at least one type of resin selected from COP and COC, for example, ZEONOR (registered trademark) and ZEONEX (registered trademark), both manufactured by Zeon Corp., and APEL (registered trademark) and APO (registered trademark), both manufactured by Mitsui Chemicals, Inc. can be used.

The content of the thermoplastic resin in the resin composition may be in a range of 50% by mass to 99% by mass, may be in a range of 55% by mass to 97% by mass, may be in a range of 60% by mass to 95% by mass, and may be in a range of 65% by mass to 90% by mass, relative to the total amount (100% by mass) of the resin composition.

Other Additives

The resin composition according to the embodiment of the present invention may contain optional additives if necessary as long as the purpose is not impaired. Examples of the additives include carbon fibers having a relative intensity ratio I_{D}/I_{G} of more than 0.6 in the Raman spectrum; various carbon blacks such as furnace black and acetylene black; nanocarbons such as carbon nanotube, graphene, and fullerene; inorganic fibrous reinforcing materials such as glass fiber, silica fiber, silica-alumina fiber, potassium titanate fiber, and aluminum borate fiber; organic fibrous reinforcing materials such as aramid fiber, polyimide fiber, and fluororesin fiber; inorganic fillers such as mica, glass bead, glass powder, and glass balloon; release agents; antioxidants; thermal stabilizers; light stabilizers; lubricants; UV absorbers; anti-fogging agents; anti-blocking agents; slip agents; dispersants; antibacterial agents; coloring agents; and fluorescent-whitening agents. The content of the additives contained in the resin composition other than the thermoplastic resin and the carbon fiber having a relative intensity ratio I_{D}/I_{G} of 0.6 or less in the Raman spectrum varies depending on the type of the additives, and may be 10% by mass or less, may be 5% by mass or less, may be 3% by mass or less, and may be 1% by mass or less, relative to the total amount of the resin composition.

Resin Composition

The resin composition according to the embodiment of the present invention can be produced by kneading or melt-kneading the thermoplastic resin and the carbon fiber having a relative intensity ratio I_{D}/I_{G} of 0.6 or less in the Raman spectrum, using, for example, a kneading machine such as a thermal roll, a kneader, or a Banbury mixer, or a twin-screw kneading extruder. When producing the resin composition, the temperature at which the thermoplastic resin is melted may be appropriately set depending on the type of the resin, and may be, for example, in a range of 200° C. to 400° C. The resulting resin composition may be formed into a pellet-shaped resin composition by using, for example, a pelletizer if necessary.

Surface Resistance Value

The resin composition according to the embodiment of the present invention has a surface resistance value in a range of 1×10² Ω to 1×10¹² Ω. The surface resistance value of the resin composition can be measured, for example, by molding the resin composition into a sheet, and measuring the surface resistance value of the sheet. The resin composition can be molded into a sheet having a size of 100 mm×100 mm×2 mm in thickness, by, for example, a 130-ton injection molding machine. When the surface resistance value of the resin composition according to the embodiment of the present invention falls within the range of 1×10² Ω to 1×10¹² Ω, the resin composition has sufficient electrical conductivity, and the water absorptivity is lowered by the carbon fiber having a relative intensity ratio I_{D}/I_{G} of 0.6 or less in the Raman spectrum, so that the resin composition can be formed into a molded product having electrical conductivity and low water absorptivity. In addition, when the surface resistance value of the resin composition according to the embodiment of the present invention falls within the range of 1×10² Ω to 1×10¹² Ω, the resin composition has sufficient electrical conductivity, which provides high antistatic properties and suppresses the absorption of dust and dirt, so that a resin composition suitable for forming, for example, semiconductor transport and storage containers can be provided in the electrical and electronic fields. The surface resistance value of the resin composition is preferably in a range of 1×10³ Ω to 1×10¹¹ Ω, and more preferably in a range of 1×10⁴ Ω to 1×10¹⁰ Ω. When the surface resistance value of the resin composition is less than 1×10² Ω, the discharge current is too large and may destroy semiconductor elements stored in the container formed using the resin composition according to the embodiment of the present invention. When the surface resistance value of the resin composition is more than 1×10¹² Ω, the surface resistance value is too high, the electrical conductivity is low, and it is difficult to exhibit excellent antistatic properties. The surface resistance value can be measured by the measurement method in Examples described later.

As a measurement apparatus for the surface resistance value, when the surface resistance value is less than 1×10⁴ Ω, for example, a milliohm HiTester 3540 (manufactured by Hioki E.E. Corp.) and a clip-type lead 9287-10 (manufactured by Hioki E.E. Corp.) can be used for measurement.

As a measurement apparatus for the surface resistance value, when the surface resistance value is 1×10⁴ Ω or more, for example, a Hiresta UP (manufactured by Dia Instruments Co., Ltd.) and a UA probe (two-deep needle probe, distance between probes of 20 mm, probe tip diameter of 2 mm) can be used for measurement.

Water Absorptivity

The water absorptivity of the molded product using the resin composition according to the embodiment of the present invention is preferably less than 0.042%, more preferably 0.041% or less, and even more preferably 0.040% or less. When the molded product composed of the resin composition according to the embodiment of the present invention has a low water absorptivity of less than 0.042%, for example, a container made of the resin composition can be suitably used in the electrical and electric fields since the water absorption and release of moisture in the container itself is suppressed, and damage to electronic components stored in the container due to the moisture can be reduced. As for the molded product for measuring the water absorptivity, a sheet having a size of 100 mm×100 mm×2 mm in thickness that is formed from the resin composition according to the embodiment of the present invention by using, for example, a 130-ton injection molding machine (manufactured by, for example, Sumitomo Heavy Industries, Ltd.) can be used. The water absorptivity of the molded product formed from the resin composition can be measured by the measurement method in

Examples described later. Specifically, the resin composition according to the embodiment of the present invention is formed into a sheet sample having a size of 100 mm×100 mm×2 mm in thickness by using a 130-ton injection molding machine; the sheet sample is immersed in water at 80° C. for 5 hours and then immersed in water maintained at room temperature for 5 minutes; the moisture on the surface of the sheet sample is wiped off and then blown off with an air gun; and the water absorptivity can be measured by dividing the difference between the weight before immersion in water and the weight after immersion in water by the weight before immersion in water.

Bending Elastic Modulus

The bending elastic modulus of a bending test piece using the resin composition according to the embodiment of the present invention, as measured in accordance with ISO 178, is preferably in a range of 3.5 to 8.0 GPa, more preferably in a range of 4.0 to 7.5 GPa, and even more preferably in a range of 4.2 to 7.0 GPa. When the bending elastic modulus of the bending test piece using the resin composition according to the embodiment of the present invention falls within the range of 3.5 to 8.0 GPa, sufficient impact resistance can be obtained, and, for example, a container made of the resin composition can reduce damage to electronic components and the like stored in the container. As the bending test piece for measuring the bending elastic modulus, a bending test piece having a size of 80 mm×10 mm×4 mm in thickness formed from the resin composition according to the embodiment of the present invention by using, for example, a 130-ton injection molding machine (manufactured by, for example, Sumitomo Heavy Industries, Ltd.) can be used.

Discharge Current

The discharge current of the molded product using the resin composition according to the embodiment of the present invention is preferably less than 2.4 A, more preferably 2.3 A or less, and even more preferably 2.2 A or less; and is preferably 0.2 A or more, and more preferably 0.5 A or more. When the discharge current of the molded product using the resin composition according to embodiment of the present invention is less than 2.4 A, a current to be discharged at one time is large enough to appropriately discharge static electricity without destroying semiconductor elements stored in a container formed by using the resin composition according to the embodiment of the present invention, and the absorption of dust and dirt can be suppressed to reduce the circuit damage and the like of the electronic components stored in the container. The measurement of the discharge current can be measured by the method in Examples described later. As the molded product for measuring the discharge current, for example, a sheet having a size of 100 mm×100 mm×2 mm in thickness formed from the resin composition according to the embodiment of the present invention by using a 130-ton injection molding machine (manufactured, for example, by Sumitomo Heavy Industries, Ltd.) can be used.

### EXAMPLES

Hereinafter, the present invention will be described in more detail with reference to Examples. However, the present invention is not limited to the following Examples as long as the gist thereof is not exceeded. The measurement and evaluation methods used in the present invention are as follows.

(A) Thermoplastic Resin

Cyclic olefin polymer: product name: ZEONOR (registered trademark), manufactured by Zeon Corp.

(B) Carbon Fiber

(B-1) Carbon fiber: carbon fiber (average fiber diameter of 10 μm, average fiber length of 6 mm, tensile elastic modulus of 631 GPa, catalog value)

(B-2) Carbon fiber: carbon fiber (average fiber diameter of 10 μm, average fiber length of 6 mm, tensile elastic modulus of 796 GPa, catalog value)

(B-3) Carbon fiber: carbon fiber (average fiber diameter of 11 μm, average fiber length of 6 mm, tensile elastic modulus of 900 GPa, catalog value)

(B-4) Carbon fiber: carbon fiber (average fiber diameter of 11 μm, average fiber length of 6 mm, tensile elastic modulus of 185 GPa, catalog value)

(B-5) Carbon fiber: carbon fiber (average fiber diameter of 8 μm, average fiber length of 6 mm, tensile elastic modulus of 220 GPa, catalog value)

### Examples 1 to 4 and Comparative Examples 1 to 3

Using a twin-screw extruder (product name: PCM-45, L/D=32 (L: screw length, D: screw diameter), manufactured by Ikegai Corp.), the (A) thermoplastic resin and the (B) carbon fiber were melt-kneaded in the blending ratio shown in Table 1 at a barrel temperature of 260° C. and a screw rotation speed of 100 rpm, cooled, and then cut to prepare a pellet composed of the resin composition in each of Examples 1 to 4 and Comparative Examples 1 to 3. In order not to break the (B) carbon fiber excessively, the (A) thermoplastic resin charged from the root of the screw (L/D=0) was melted into a kneading element placed at L/D=12, and then the (B) carbon fiber was charged from L/D=20.

In Example 4 only, the (A) thermoplastic resin and the (B) carbon fiber were charged from the root of the screw (L/D=0).

The resulting resin composition pellet was dried in a dryer at 90° C. for 5 hours.

The dried resin composition pellet was used to prepare a sheet sample having a size of 100 mm×100 mm×2 mm in thickness and a test piece for bending elastic modulus test (ISO standard, 80 mm×10 mm×4 mm in thickness, bending test piece) by using a 130-ton injection molding machine (product name: SE130D, manufactured by Sumitomo Heavy Industries, Ltd.). The cylinder temperature of the 130-ton injection molding machine was set to 260° C., and the molding temperature was set to 60° C.

(1) Relative Intensity Ratio I_{D}/I_{G} in Raman Spectrum of Carbon Fiber

The Raman spectrum of the (B) carbon fiber contained in the sheet sample was measured by microscopic Raman spectroscopy.

Apparatus name: DXR2 microscopic laser Raman microscope (manufactured by Thermo Fisher Scientific Inc.)

Laser wavelength: 532 nm Laser output level: 1.0 mW Grating: 900 lines/mm The end of baseline was set to a wavenumber position with the lowest peak intensity in the Raman spectrum in a range of left end: 2,100 to 1,800 cm⁻¹ and right end: 1,100 to 600 cm⁻¹. The relative intensity ratio (I_{D}/I_{G}) of the peak intensity I_{D} in a wavenumber range of 1,320 cm⁻¹ to 1,370 cm⁻¹ to the peak intensity I_{G} in a wavenumber range of 1,560 cm⁻¹ to 1,600 cm⁻¹ was determined from the Raman spectrum of the sheet sample obtained from the resin composition in each of Examples and Comparative Examples. The results are shown in Table 1.

(2) Aspect Ratio of Carbon Fiber

The resin composition pellet was heat-pressed at 260° C. to prepare a thin piece having a diameter of 30 mm and a thickness of 0.05 mm, and the thin piece was subjected to image analysis using an optical microscope (product name: OPTIPHOT-2, manufactured by Nikon corp.). The major axis and the minor axis of 10 carbon fibers were measured to determine the average value of the major axis as the average fiber length and the average value of the minor axis as the average fiber diameter. The results are shown in Table 1.

(3) Surface Resistance Value

(3-1) When the surface resistance value of the sample sheet was less than 1×10⁴ Ω, a milliohm HiTester 3540 (manufactured by Hioki E.E. Corp.) and a clip-type lead 9287-10 (manufactured by Hioki E.E. Corp.) were used for measurement. A silver paste having a size of approximately 1 to 2 mmφ was coated on the sheet sample to form an electrode, and the clip-type lead was connected to the electrode to measure the surface resistance value. The measurement was performed with the following applied voltage.

(3-2) When the surface resistance value of the sample sheet was 1×10⁴ Ω or more, a Hiresta UP (manufactured by Dia Instruments Co., Ltd.) and a UA probe (two-deep needle probe, distance between probes of 20 mm, probe tip diameter of 2 mm) were used for measurement. The sheet sample was measured by attaching a conductive rubber (volume low efficiency: 5 Ω·cm) to the contact pin tip of the UA probe with a conductive adhesive to stabilize contact with the sheet sample surface. By attaching the conductive rubber to the UA probe, fluctuations in the contact area caused by the roughness of the surface to be measured are reduced, so that the surface resistance value can be measured accurately and stably. The results are shown in Table 1.

Applied voltage of 1 V for the surface resistance value of less than 1×10⁴ Ω

Applied voltage of 10 V for the surface resistance value of 1×10⁴ Ω or more and less than 1×10¹⁰ Ω

Applied voltage of 100 V for the surface resistance value of 1×10¹⁰ Ω or more and less than 1×10¹⁴ Ω

(4) Water Absorptivity

The sheet sample was dried in a dryer at 90° C. for 24 hours. After drying, the sheet sample was placed in a desiccator and cooled to room temperature (25° C.±5° C.), and the weight W₁ (g) of the sheet sample was measured.

Next, the sheet sample was immersed in deionized water at 80° C. for 5 hours; cooled in deionized water maintained at room temperature (25° C.±5° C.) for 5 minutes; and removed from the deionized water. Then, the surface of the sheet sample was wiped off, and the moisture on the surface was blown off with an air gun to measure the weight W₂ (g) of the sheet sample immediately.

The water absorptivity was determined by subtracting the weight W₂ of the sheet sample after immersion from the weight W₁ of the sheet sample before immersion in the deionized water at 80° C., and dividing the result by the weight W₁ of the sheet sample before immersion in the deionized water at 80° C. Specifically, the water absorptivity was determined by the following formula (1). The results are shown in Table 1.

Water absorptivity (%)=(W₁−W₂)/W₁×100 (1)

(5) Bending Elastic Modulus

In accordance with ISO 178, the test piece for bending elastic modulus test formed from the resin composition in each of Examples and Comparative Examples was measured using a universal testing machine (product name: TISY-2600, manufactured by TISY). The results are shown in Table 1.

(6) Discharge Current

The injection-molded sample (100 mm×100 mm×2 mm in thickness) was placed on a charge plate monitor (MODEL 700A, manufactured by Hugle Electronics Inc.), 1,000 V was applied to the sample on the charge plate, and then the sample was floated from the ground with an electrostatic capacity of 20 pF. Next, a copper wire having an end terminal connected to the ground was brought into contact with the sample and discharged to generate a current with an amplitude on the order of nanoseconds, which gradually attenuated. The highest current value during the time was defined as the discharge current. The discharge current was measured using a current probe (CT-1, manufactured by Tektronix Inc.) and a digital oscilloscope (product name: LC584A, manufactured by LeCroy). The measurement was repeated 10 times for one sheet sample to determine the average value of the discharge current. The results are shown in Table 1.

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| (A) Thermoplastic | Cyclic olefin | 84 | 83 | 82 | 70 | 60 | 85 | 85 |
| resin | polymer (COP) | | | | | | | |
| (B) Carbon fiber | Carbon fiber (B-1) | 16 | — | — | — | 40 | — | — |
| | Carbon fiber (B-2) | — | 17 | — | — | — | — | — |
| | Carbon fiber (B-3) | — | — | 18 | 30 | — | — | — |
| | Carbon fiber (B-4) | — | — | — | — | — | 15 | — |
| | Carbon fiber (B-5) | — | — | — | — | — | — | 15 |

| | | | | | | | |
|---|---|---|---|---|---|---|---|
| Relative intensity ratio in Raman | 0.37 | 0.20 | 0.13 | 0.14 | 0.38 | 0.95 | 1.00 |
| spectrum (I_{D}/I_{G)} | | | | | | | |
| Aspect ratio of carbon fiber | 33 | 25 | 22 | 8 | 31 | 38 | 64 |
| Surface resistance value (Ω) | 7 × 10⁴ | 5 × 10⁷ | 7 × 10⁹ | 4 × 10⁶ | 3 × 10¹ | 2 × 10⁴ | 4 × 10³ |
| Water absorptivity (%) | 0.040 | 0.039 | 0.036 | 0.037 | 0.042 | 0.084 | 0.057 |
| Bending elastic modulus (GPa) | 6.3 | 5.2 | 5.6 | 4.5 | 8.9 | 3.4 | 6.4 |
| Discharge current (A) | 2.2 | 1.4 | 0.8 | 1.6 | 6.7 | 2.4 | 2.8 |

The sheet formed from the resin composition in each of Examples 1 to 4 by the injection molding machine contained a carbon fiber having a relative intensity ratio I_{D}/I_{G} of 0.6 or less in the Raman spectrum and a cyclic polyolefin polymer; the surface resistance value of the sheet formed by the injection molding machine was in a range of 1×10² Ω to 1×10¹² Ω; the water absorptivity was lowered to 0.040% or less; and thus the sheet had low water absorbency and excellent electrical conductivity. The bending elastic modulus of the sheet formed from the resin composition in each of Examples 1 to 4 was in a range of 3.5 to 8.0 GPa, and thus the sheet had sufficient impact resistance. In addition, the discharge current of the sheet formed by using the resin composition in each of Examples 1 to 4 was in a range of 0.2 A or more and less than 2.4 A, so that the sheet was capable of discharging static electricity appropriately, suppressing the adsorption of dust and dirt, and reducing the circuit damage of electronic components stored in a container.

The sheet formed from the resin composition in Comparative Example 1 by the injection molding machine had a low surface resistance value and an excessively large discharge current. In Comparative Examples 2 and 3, the relative intensity ratio I_{D}/I_{G} of the carbon fiber was more than 0.6, and although the surface resistance value was in the range of 1×10² Ω to 1×10¹² Ω, the water absorptivity could not be reduced and the discharge current was higher than that of the sheet formed by using the resin composition in each of Examples 1 to 4.

### INDUSTRIAL APPLICABILITY

The resin composition of the present invention can be suitably used as a material for packaging materials and containers for electronic components such as semiconductor light emitting elements in technical fields where low water absorbency and electrical conductivity are required, for example, in the electrical and electronic fields.

1. A resin composition, comprising a carbon fiber and a thermoplastic resin,
wherein the carbon fiber has a relative intensity ratio (I_{D}/I_{G}) of the peak intensity I_{D} in a wavenumber range of 1,320 cm⁻¹ to 1,370 cm⁻¹ to the peak intensity I_{G} in a wavenumber range of 1,560 cm⁻¹ to 1,600 cm⁻¹ of 0.6 or less in the Raman spectrum measured by microscopic Raman spectroscopy, and
wherein the resin composition has a surface resistance value in a range of 1×10² Ω to 1×10¹² Ω.

2. The resin composition according to claim 1, having a relative intensity ratio (I_{D}/I_{G}) of the carbon fiber of 0.12 or more.

3. The resin composition according to claim 1, having an aspect ratio of the carbon fiber of 10 or more.

4. The resin composition according to claim 1, having a content of the carbon fiber of 1 to 50% by mass relative to the total resin composition.

5. The resin composition according to claim 1, wherein the thermoplastic resin comprises at least one type selected from a cyclic olefin polymer and a cyclic olefin copolymer.

6. The resin composition according to claim 1, having a bending elastic modulus, as measured in accordance with ISO 178, of 3.5 to 8.0 GPa.
